(19) United States
(12) Patent Application Publication
(10) Pub. No.: US 2024/0078615 A1
(43) Pub. Date: Mar. 7, 2024

(54) Zoku App

(71) Applicant: Jacqueline Omorogbe, Powder Springs, GA (US)

(72) Inventor: Jacqueline Omorogbe, Powder Springs, GA (US)

(21) Appl. No.: 17/902,799

(22) Filed: Sep. 3, 2022

(51) Int. Cl. G06Q 50/00

(52) U.S. Cl. CPC G06Q 50/01

(57) ABSTRACT

Many people are tired of set routines and planning activities takes too much time and effort. The Zoku app takes out the planning and fills it with mystery by giving users a series of clues to a mystery activity/event in their area. Let's say it's a friday night, you want to go out, but you don't know what to do and you don't feel like going through the planning process. You simply unlock an adventure in Zoku. You select filters, such as your budget, distance and activity level. Then clues will be generated that will lead you to an event/activity. The catch is that users are blinded to the event/activity they will be participating in until they get to the event/activity location. Users can either start the activity then or save it for later.

### ABOUT APP

Zoku is an app built upon mystery and adventure. Most days, people have a set routine and with these routines come expectations. This can result in people living relatively predictable and mundane lives. When people wish to break this cycle, it can be difficult to think of exciting ways to spend their time. Zoku generates unique activities for people to participate in while adding more thrill to the adventure by only revealing the activity when users get close to the activity location. The goal is to provide exhilaration on a unique excursion.

### Product and Services

Zoku is a free-mobile app that keeps users' lives more mysterious and adventurous by randomly selecting events and activities in cities based on the users' selected filters and location. What makes this app unique is that users are blinded to the activity/event until they reach the event/activity location. To create an account, users provide their name, password, date of birth, phone number, and email or they may use a google or Facebook account log in. Users will also be given the option to upload a profile picture, if they do not have one already. Once an account is created, users can unlock adventures at any time. Users will have the option to select categories and enter the amount they are willing to spend at the selected event, distance, activity level, and whether or not they seek an indoor or outdoor activity.

### First Clue

Once users apply filters, the first clue will appear displaying the cost of the event, the materials needed, suggested event attire, time of the event, and whether it is non-refundable. To move on to the next clue, users will hit the “accept” button.

### Second Clue

The second clue will display the initial address (usually an address that is within 1 mile of the event/activity address). Users need to make their way to the initial address and click “here” for the third clue to appear.

### Third Clue

The third clue will reveal the event/activity name and the final (event) address. Users can then decide whether or not they want to partake in the event/activity. Users also can take photos and upload them after they complete the event/activity.

### FEATURES

### Profile

After creating an account, users will have their profiles set up listing their name, phone number, email and profile picture.

### Clipboard

Users can post pictures and videos from all their adventures. Users can make connections and follow each other's experiences by adding friends. Users can also share their experiences with the app on other social media platforms such as facebook and instagram.

### Invites/Rewards Points

Before taking an adventure, users can invite their followers to join them in the mystery event/activity. The selected followers will receive a notification about the adventure with the option to accept or reject it. Users can invite their friends to download Zoku.

### Unlock an Adventure

This is where users will submit the necessary information in order to unlock their adventure. Users will first select a category, which will lead them to the filters page. In the filters page, users will be prompted to select the amount they are willing to spend at the selected event, how far they are willing to travel, activity level, and whether or not they seek an indoor or outdoor activity. Users will also be able to select whether they would like to invite friends to participate in the adventure with them. Once this information is provided, the first clue will unlock and the adventure will begin.

1: An events and activities phone application, comprising of:
A. Events and activities categories users can choose from: group activity, self-care, new to the city, restaurants, individual activity, date, event, nightlife.
B. Events and activities filters after users select categories: location, budget, activity level, activity type (indoor/outdoor activity), and distance
C. Events and activities clues display after users choose filters: first clue displays event/activity attire, event/activity cost, event/activity date and time, and materials needed. To move on to the next clue, users will hit the “accept” button. The second clue displays the initial address (usually an address that is within 1 mile of the event/activity address). Users need to make their way to the initial address and click “here” for the third clue to appear. The third clue displays the event/activity name and the final (event) address. Users can then decide whether or not they want to partake in the event/activity.
D. The ability for users to take photos and upload them after completing events/activities.
E. A clipboard that includes a “Friends” and “Past Adventures” section.

2: A blinded. activities and events phone application that blinds users to activities and events until users go through three clues and reach the event/activity location (the final address/clue). Users are blinded meaning that event and activity names and addresses are not revealed until users are within one mile of the event/activity location. For the second clue, users are only given an initial address, which is always within one mile of the actual event/activity address. Users are instructed to go to the initial address and click “here” for the final address to be revealed.
